(19) United States
(12) Patent Application Publication
(10) Pub. No.: US 2021/0124360 A1
(43) Pub. Date: Apr. 29, 2021

(54) SYSTEM AND PROCESS FOR CLOSEST IN PATH VEHICLE FOLLOWING

(71) Applicant: GM Global Technology Operations LLC, Detroit, MI (US)

(72) Inventors: Ryan A. MacDonald, Waterloo (CA); Mohammadali Shahriari, Markham (CA); Dorothy Lui, North York (CA); Donovan J. Wisner, Ann Arbor, MI (US)

(73) Assignee: GM GLOBAL TECHNOLOGY OPERATIONS LLC, Detroit, MI (US)

(21) Appl. No.: 16/661,498

(22) Filed: Oct. 23, 2019

(51) Int. Cl. G05D 1/02; G01C 21/36; G06K 9/00

(52) U.S. Cl. CPC G05D 1/0219; G05D 1/0214; G05D 2201/0213; G01C 21/3647; G06K 9/00798; G05D 1/0246

(57) ABSTRACT

A system for closest in path vehicle following is provided. The system includes a sensor device of a vehicle to be controlled generating data related to a closest in path vehicle and related to a drivable surface in front of the vehicle. The system further includes a navigation control module including a computerized processor operable to monitor the data from the sensor device, evaluate the data to determine a quality measure of a path followed by the closest in path vehicle, and if the quality measure of the closest in path vehicle is above a high-quality candidate threshold, generate a breadcrumbing navigation path based upon the data. The system further includes a vehicle control module controlling the vehicle to be controlled based upon the breadcrumbing navigation path.

### INTRODUCTION

The disclosure generally relates to a system and process for closest in path vehicle following for an autonomous or semi-autonomous vehicle.

Navigation systems and methods for autonomous and semi-autonomous vehicles utilize computerized algorithms to determine a navigational path for the vehicle being controlled. Digital maps and sensor inputs are useful to set the navigational path for the vehicle. Sensor inputs can include image recognition of lane markers and street features. Sensor inputs may further include image, radar, light detection and ranging (LIDAR), or other similar sensor recognition types to monitor locations of other vehicles relative to the vehicle being controlled, for example, to prevent the vehicle being controlled from getting too close to another vehicle in traffic.

### SUMMARY

A system for closest in path vehicle following is provided. The system includes a sensor device of a vehicle to be controlled generating data related to a closest in path vehicle and related to a drivable surface in front of the vehicle. The system further includes a navigation control module including a computerized processor operable to monitor the data from the sensor device, evaluate the data to determine a quality measure of a path followed by the closest in path vehicle, and if the quality measure of the closest in path vehicle is above a high-quality candidate threshold, generate a breadcrumbing navigation path based upon the data. The system further includes a vehicle control module controlling the vehicle to be controlled based upon the breadcrumbing navigation path.

In some embodiments, determining the quality measure includes quantifying the path followed by the closest in path vehicle with a numerical value.

In some embodiments, evaluating the data includes determining an oscillation of the closest in path vehicle on the drivable surface based upon the data, comparing the oscillation to a threshold oscillation value, and determining the quality measure of the closest in path vehicle based upon the comparing.

In some embodiments, determining the oscillation of the closest in path vehicle includes monitoring a heading error of the closest in path vehicle.

In some embodiments, determining the oscillation of the closest in path vehicle includes monitoring a lateral position error of the closest in path vehicle.

In some embodiments, determining the oscillation of the closest in path vehicle includes monitoring a relative position of the closest in path vehicle to another vehicle on the drivable surface.

In some embodiments, determining the oscillation of the closest in path vehicle includes monitoring a curvature error of the vehicle

In some embodiments, evaluating the data includes determining a stability of the closest in path vehicle on the drivable surface based upon the data, comparing the stability to a threshold stability value, and determining the quality measure of the closest in path vehicle based upon the comparing.

In some embodiments, determining the stability of the closest in path vehicle on the drivable surface includes evaluating whether the closest in path vehicle is tracking an established lane of travel.

In some embodiments, determining the stability of the closest in path vehicle on the drivable surface includes evaluating a dynamic trajectory of the closest in path vehicle in an established lane of travel.

In some embodiments, the sensor device comprises one of a camera device, a radar device, a lidar device, and an ultrasonic device.

In some embodiments, controlling the vehicle to be controlled based upon the breadcrumbing navigation path includes determining a lane geometry on the drivable surface, fusing the lane geometry with the breadcrumbing navigation path to create a fused navigation path, and controlling a trajectory of the vehicle to be controlled based upon the fused navigation path.

In some embodiments, the vehicle control module further controls a distance from the closest in path vehicle based upon the quality measure.

In some embodiments, the vehicle control module further controls vehicle braking based upon the quality measure.

According to one alternative embodiment, a system for closest in path vehicle following is provided. The system includes a sensor device of a vehicle to be controlled generating data related to a closest in path vehicle and related to a drivable surface in front of the vehicle. The system further includes a navigation control module including a computerized processor operable to monitor the data from the sensor device, evaluate the data to determine a quality measure of a path followed by the closest in path vehicle, the quality measure including a numerical value quantifying a path followed by the closest in path vehicle, and, if the quality measure of the closest in path vehicle is above a high-quality candidate threshold, generate a breadcrumbing navigation path based upon the data. The system further includes a vehicle control module controlling the vehicle to be controlled based upon the breadcrumbing navigation path.

According to one alternative embodiment, a process for closest in path vehicle following is provided. The process includes gathering data with a sensor device of a vehicle to be controlled, the data being related to a closest in path vehicle and related to a drivable surface in front of the vehicle. The process further includes within a computerized processor, monitoring the data from a sensor device, evaluating the data to determine a quality measure of a path followed by the closest in path vehicle, and if the quality measure of the closest in path vehicle is above a high-quality candidate threshold, generating a breadcrumbing navigation path based upon the data. The process further includes controlling the vehicle to be controlled based upon the breadcrumbing navigation path.

In some embodiments, evaluating the data includes evaluating a stability of the path followed by the closest in path vehicle.

In some embodiments, evaluating the data includes evaluating an oscillation of the path followed by the closest in path vehicle.

In some embodiments, the process further includes automatically stopping the vehicle to be controlled if the quality measure of the closest in path vehicle is below a full stop warranted threshold.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 illustrates terms which may be useful in defining a process to quantify CIPV behavior, in accordance with the present disclosure;

FIG. 2 schematically illustrates exemplary control architecture useful to operate the disclosed process and system, in accordance with the present disclosure;

FIG. 3 schematically illustrates an exemplary data communication system within a vehicle being controlled, in accordance with the present disclosure;

FIG. 4 illustrates an exemplary vehicle being controlled by the disclosed process and system, including devices and modules useful to certifying a CIPV target as high-quality, in accordance with the present disclosure;

FIG. 5 schematically illustrates an exemplary computerized navigation control module, in accordance with the present disclosure; and

FIG. 6 is a flowchart illustrating an exemplary process to evaluate a CIPV target and determine whether the CIPV target is a high-quality candidate to use for breadcrumbing navigation, in accordance with the present disclosure.

### DETAILED DESCRIPTION

A process and system for closest vehicle in path following for an autonomous or semi-autonomous vehicle is provided including a real-time determination whether a closest vehicle in a current path for the vehicle being controlled is a high-quality candidate to follow a path taken by the closest vehicle in the current path. A high-quality candidate may exhibit low oscillation behavior. A high-quality candidate may exhibit high stability with respect to the road geometry.

Breadcrumbing navigation by following the closest vehicle in path or Closest In Path Vehicle (CIPV) can be used to deal with intermittent lane marking quality in lane following control. Breadcrumbing refers to utilizing locations of other vehicles in the path of the vehicle being controlled to set a path for the vehicle being controlled. Breadcrumbing navigation strategies may not differentiate good versus bad CIPV behavior. A real-time process and system are provided that identifies a high-quality CIPV target to follow. This process, by utilizing the target CIPV states reported by camera and radar, may quantify the CIPV driver's behavior or assign a numerical value to the quality of the driving exhibited by the vehicle concerning lane following performance. The process may generate a value describable as a quality measure which can be a numerical value, for example, between 1 and 100, with a larger value describing higher quality behavior of a CIPV. The quality measure generated by this process can be used by breadcrumbing navigation, for example, by comparing it to a minimum quality threshold of, for example, 75, to decide whether or not to utilize the CIPV path by measuring the confidence or quality of that path. In other embodiments, the quality measure can be some other scalar value, for example, grade A to grade D or five stars to one star. Confidence or a quality measure of the CIPV path can be evaluated or determined in terms of oscillation of the CIPV or stability of the CIPV. Stability of a CIPV can be measured or evaluated in a number of ways, including but not limited to determining whether a CIPV is tracking a lane of travel and monitoring a dynamic trajectory of the CIPV with respect to the road or lane of travel. Further, the disclosed process and system are useful to providing improved vision range, meaning that knowledge about the roadway and information important to traveling upon the roadway are improved.

The quality of lane markings may not be high for lane following features and this causes intermittent feature availability. However, the trajectory of the CIPV may not be trustworthy due to poor or inconsistent driver maneuvers. Drivers can be distracted, can make last minute decisions to change lanes, can drive too aggressively, and can generally not set a good example for a following vehicle. Following a CIPV indiscriminately can cause a vehicle to follow a wrong path or oscillate between a wrong path and a correct lane. Excessive variation in CIPV data can create noise in a breadcrumbing navigation operation.

By examining the CIPV driver's behavior and selectively employing location and trajectory data from the CIPV for breadcrumbing path planning, the disclosed system can increase feature availability and safety. The breadcrumbing data collected and certified to be high-quality can be used individually or can be used to reinforce and rationalize camera inputs for lane following. The disclosed system can provide better camera/lane interpretation, vision range, and quality without new hardware. In one embodiment, the disclosed process and system utilize a fusion of CIPV states including but not limited to a lateral position error, a heading error, and a curvature error to certify and selectively utilize high-quality CIPV data. Lateral position error describes how far away the CIPV is from a nominal or desired center of a lane of travel. Heading error describes an error between an actual heading of the CIPV from a nominal or desired heading based upon geometry a lane of travel. Curvature error describes an error between a curvature navigated by the CIPV as compared to a nominal or desired curvature based upon geometry of a lane of travel. By measuring or estimating lateral position error, heading error, and curvature error, the quality of the CIPV as a candidate to be followed can be evaluated or quantified.

An exemplary algorithm for determining or quantifying a quality of a CIPV as a candidate to be followed is provided as Equation 1.

f(X_{c})=∫_{t-Δt}^{t}(α₁|e_{Y}|+α₂|e_{ψ}|+α₃|e_{ρ}|dt)+α₄∫_{ω=0Hz}^{5Hz}FFT( [symbol] e_{Y} [symbol] ₜ, [symbol] e_{ψ} [symbol] ₜ, [symbol] e_{ρ} [symbol] ₜ)²dω [1]

Equations 2, 3, and 4 describe terms in Equation 1.

$$\begin{matrix}{e}_{Y} = {y}_{cipv} - {y}_{blue Line} ( {x}_{cipv} ) \text{:} & [ 2 ] \\ {e}_{ψ} = {ψ}_{cipv} - \frac{d}{dx} ( {y}_{blueLine} ( {x}_{cipv} ) ) \text{:} & [ 3 ] \\ {e}_{ρ} = \frac{d}{dt} {ψ}_{cipv} / {v}_{x} - \frac{{d}^{2}}{{dx}^{2}} {y}_{blueLine} ( {x}_{cipv} ) \text{:} & [ 4 ]\end{matrix}$$

e_{ψ} describes a heading error for the CIPV. e_{Y} describes a lateral position error for the CIPV. e_{ρ} describes a curvature error for the CIPV. The term y_{blueline} describes a lateral position of a blueline or a target/desired/reference trajectory. Terms α₁, α₂, α₃, and α₄ describe weighting factors for quantification. The term Δt describes a length of moving time window. The operation FFT describes a Fast Fourier Transform algorithm applied within Equation 1. In one embodiment, the FFT can be performed using the Geortzel Algorithm available in the art. The term ω describes a frequency of low energy band. Equations 5, 6, and 7 further describe terms of Equation 1, describing the vector over window the past Δt₂ seconds since t_{now}.

[symbol]

e_{Y} [symbol] ₜ_{_{now}}={e_{Y}(t):∀t∈[t_{now}−Δt₂,t_{now}]} [5]

[symbol]

e_{ψ} [symbol] ₜ_{_{now}}={e_{ψ}(t):∀t∈[t_{now}−Δt₂,t_{now}]} [6]

[symbol]

e_{ρ} [symbol] ₜ_{_{now}}={e_{ρ}(t):∀t∈[t_{now}−Δt₂,t_{now}]} [7]

Equation 1 is provided as an exemplary algorithm for evaluating whether a target CIPV is a high-quality candidate to utilize for breadcrumbing navigation. A number of alternative algorithms are envisioned, and the disclosure is not intended to be limited to the examples provided herein.

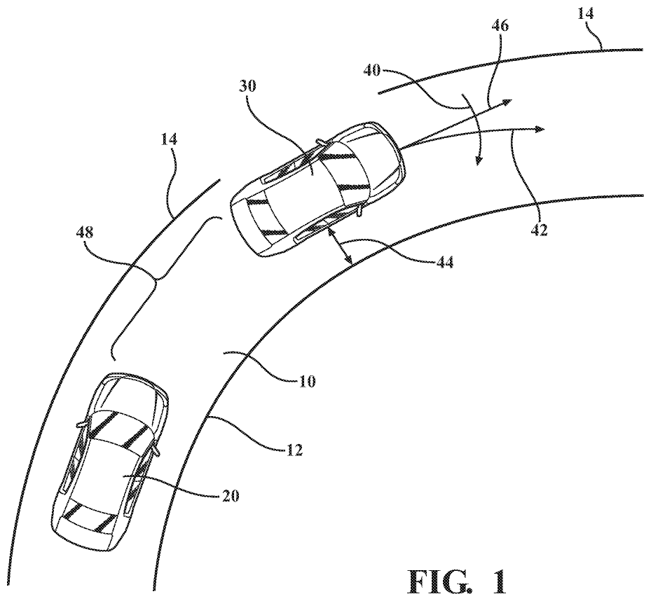

FIG. 1 illustrates terms which may be useful in defining a process to quantify CIPV behavior. A portion of the terms of Equation 1 are described in FIG. 1. Vehicle being controlled 20 is illustrated upon road surface 10 which includes lane markings 12 and 14. Lane marking 14 is illustrated as intermittent, which can be problematic for navigational systems that would solely utilize lane markings to navigate the vehicle. CIPV 30 is illustrated upon road surface 10. Various terms can be defined based upon CIPV 30 and its motion in relation to the road surface 10 and vehicle being controlled 20. Term 40 describes e_{ψ} or a heading error for CIPV 30. Term 46 describes an instantaneous heading of CIPV 30. Term 44 describes e_{Y} or a lateral position error of CIPV 30. Term 42 describes e_{ρ} or a curvature error for CIPV 30. Term 48 illustrates Δt which describes a length of moving time window.

Controlling the vehicle to be controlled based upon a breadcrumbing navigation path can include a number of alternative embodiments. In one exemplary embodiment, the vehicle to be controlled can include equipment to determine a lane geometry on the drivable surface. The vehicle can include a control module to fuse the lane geometry with the breadcrumbing navigation path to create a fused navigation path. A trajectory of the vehicle to be controlled can then be controlled based upon the fused navigation path.

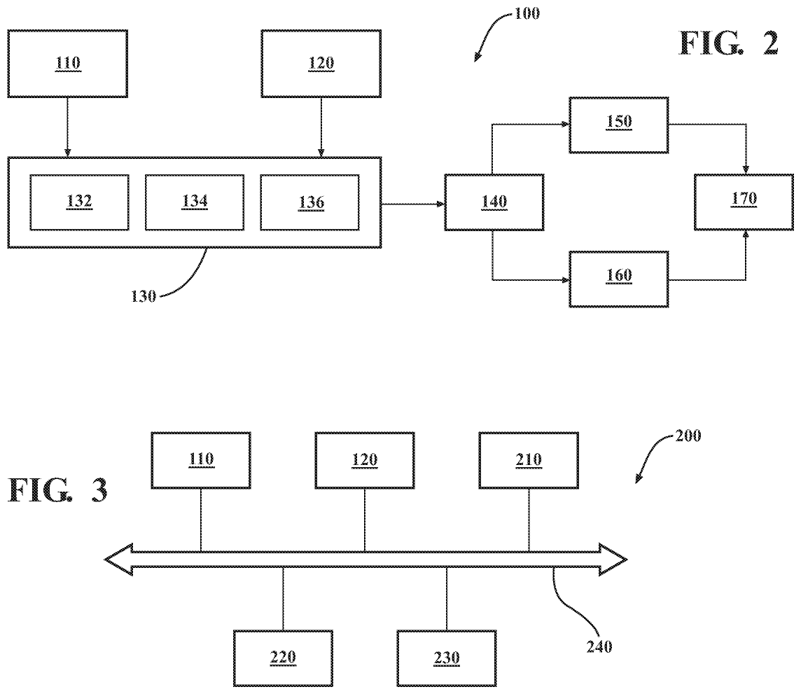

FIG. 2 schematically illustrates exemplary control architecture useful to operate the disclosed process and system. Control architecture 100 is illustrated including camera device 110, digital map database 120, data fusion module 130, mission planning module 140, longitudinal control module 150, lateral control module 160, and electronic power steering/acceleration/braking module 170. Camera device 110 captures a series of images related to an environment proximate to and in the path of the vehicle being controlled, including but not limited to images of the road surface, images of lane markers, images of potential obstacles near the vehicle, images of vehicles around the vehicle being controlled, and other images of relevant information to controlling a vehicle. Digital map device 120 includes data regarding an area proximate to the vehicle being controlled including historically documented road geometry, synthesized data such as vehicle to vehicle or infrastructure to vehicle data regarding road geometry, and other information that can be monitored and stored about a particular area upon which the vehicle may travel. Data fusion module 130 includes CIPV module 132, CIPV data certification module 134, and breadcrumbing navigation module 136. CIPV module 132 gathers information regarding a CIPV and generates data from the information including exemplary values of motion frequency, trajectory, and lateral location of the CIPV within a lane of travel. CIPV data certification module 134 receives the generated data from CIPV module 132 and analyzes the data to determine whether the behavior of the CIPV warrants the CIPV being classified as a high-quality target and useful to gather data for breadcrumbing navigation. If CIPV data certification module 134 determines that the CIPV is a high-quality target, breadcrumbing navigation module 136 utilizes data from CIPV module 132 to generate a breadcrumbing navigation plot, enabling the vehicle being controlled to base navigational movements partially or wholly upon the movement of/following the CIPV.

Mission planning module 140 utilizes the breadcrumbing navigation plot from breadcrumbing navigation module 136 and other available information to generate a commanded navigation plot. Longitudinal control module 150 and lateral control module 160 utilize the commanded navigation plot to determine desired vehicle speed and desired vehicle trajectory. Electronic power steering/acceleration/braking module 170 utilizes outputs from longitudinal control module 150 and lateral control module 160 to effect control over navigation of the vehicle being controlled. Control architecture 100 is provided as one exemplary embodiment of a control architecture that can be utilized to implement the disclosed process and system. Other embodiments are envisioned, and the disclosure is not intended to be limited to the examples provided herein.

FIG. 3 schematically illustrates an exemplary data communication system within a vehicle being controlled. Data communication system 200 is illustrated including a camera device 110, a digital map database 120, a sensor device 210, a navigational control module 220, and a vehicle control module 230, each respectively communicatively connected to vehicle data bus 240. Sensor device 210 can include one or more of a radar device, LIDAR device, ultrasonic device, or other similar device useful for gathering data about the environment of a vehicle and behavior of other vehicles upon a roadway. Vehicle data bus 240 includes a communication network capable of transferring data quickly back and forth between various connected devices and modules. Data can be collected from each of camera device 110, digital map database 120, and sensor device 210 and transferred to navigational control module 220. Navigational control module 220 includes a computerized processor and programmed code operable to create a commanded navigation plot useful to navigate the vehicle being controlled over a road surface proximate to the vehicle.

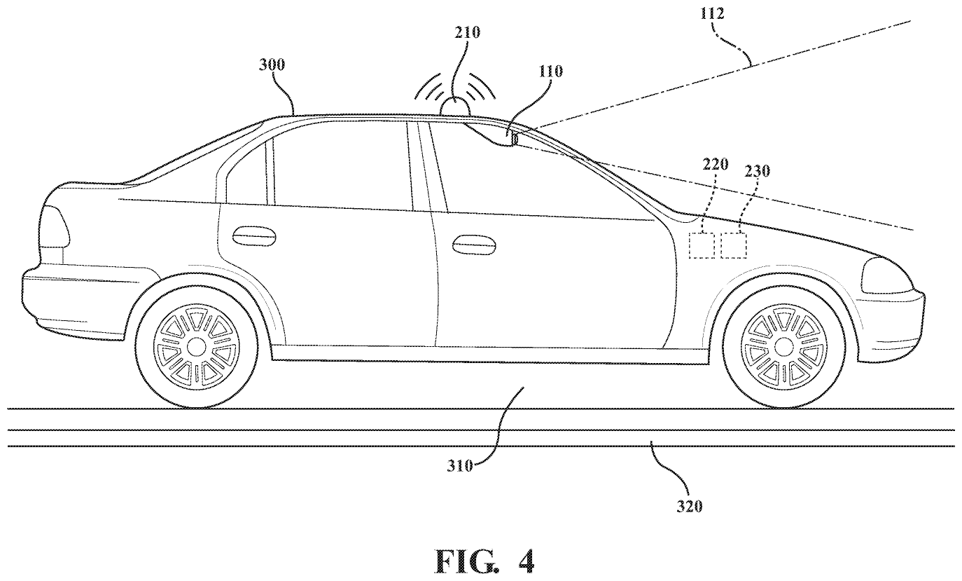

FIG. 4 illustrates an exemplary vehicle being controlled by the disclosed process and system, including devices and modules useful to certifying a CIPV target as high-quality. Vehicle being controlled 300 is illustrated upon road surface 310 including lane markings 320. Vehicle 300 is illustrated including navigation control module 220, vehicle control module 230, camera device 110, and sensor device 210. Camera device 110 includes field of view 112 and is positioned to capture images of road surface 310 and other objects and obstacles near vehicle being controlled 300, including a nearby vehicle that can be a CIPV. Sensor device 210 can additionally provide data regarding objects near vehicle being controlled 300. Navigation control module 220 receives data from camera device 110 and other sources and generates a commanded navigation plot according to the disclosed process. Vehicle control module 230 utilizes the commanded navigation plot to control navigation of vehicle being controlled 300 upon road surface 310. Vehicle being controlled 300 is provided as an exemplary vehicle utilizing the disclosed process and system. Other embodiments are envisioned, and the disclosure is not intended to be limited to the examples provided herein.

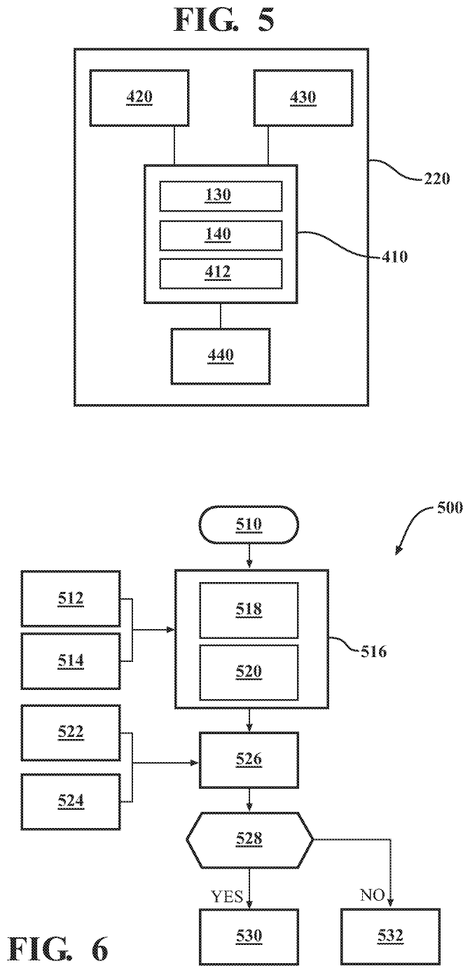

Various control modules may be utilized within the disclosed system to operate the disclosed process. Control modules may include a computerized device including a computerized processor including memory capable of storing programmed executable code. A control module may be operated upon a single computerized device or may span several computerized devices. FIG. 5 schematically illustrates an exemplary computerized navigation control module. Navigation control module 220 includes computerized processor device 410, communications module 430, data input/output module 420, and memory storage device 440. It is noted that navigation control module 220 may include other components and some of the components are not present in some embodiments.

The processor device 410 may include memory, e.g., read only memory (ROM) and random-access memory (RAM), storing processor-executable instructions and one or more processors that execute the processor-executable instructions. In embodiments where the processor device 410 includes two or more processors, the processors may operate in a parallel or distributed manner. Processor device 410 may execute the operating system of the navigation control module 220. Processor device 410 may include one or more modules executing programmed code or computerized processes or methods including executable steps. Illustrated modules may include a single physical device or functionality spanning multiple physical devices. In the illustrative embodiment, the processor device 410 also includes data fusion module 130, mission planning module 140, and lane data synthesis module 412, which are described in greater detail below.

The data input/output module 420 is a device that is operable to take data gathered from sensors and devices throughout the vehicle and process the data into formats readily usable by processor device 410. Data input/output module 420 is further operable to process output from processor device 410 and enable use of that output by other devices or control modules throughout the vehicle.

The communications module 430 may include a communications/data connection with a bus device configured to transfer data to different components of the system and may include one or more wireless transceivers for performing wireless communication.

The memory storage device 440 is a device that stores data generated or received by the navigation control module 220. The memory storage device 440 may include, but is not limited to, a hard disc drive, an optical disc drive, and/or a flash memory drive.

The data fusion module 130 is described in relation to FIG. 2 and may include programming operable to monitor data regarding a CIPV target, evaluate whether the CIPV target is a high-quality candidate to be used for breadcrumbing navigation, and generate a breadcrumbing navigation plot based upon the data regarding the CIPV target.

Mission planning module 140 is described in relation to FIG. 2 and may include programming operable to generate a commanded navigation plot based upon the generated breadcrumbing navigation plot and other navigational information such as lane data generated by lane data synthesis module 412.

Lane data synthesis module 412 monitors information related to a current lane of travel from various sources, including data from a camera device, data from a sensor device, data from a digital map device, and lane data synthesis module 412 projects or estimates the metes and bounds of a current lane of travel from available sources. Map error can exist within the map database or in data related to a current location. Lane data synthesis module 412 may include algorithms useful to localize information, fuse various sources of information, and reduce map error. These metes and bounds are made available to other modules as lane data.

Navigation control module 220 is provided as an exemplary computerized device capable of executing programmed code to evaluate and selectively utilize data from a CIPV target to generate a breadcrumbing navigation plot. A number of different embodiments of navigation control module 220, devices attached thereto, and modules operable therein are envisioned, and the disclosure is not intended to be limited to examples provided herein.

FIG. 6 is a flowchart illustrating an exemplary process to evaluate a CIPV target and determine whether the CIPV target is a high-quality candidate to use for breadcrumbing navigation. Process 500 starts at step 510 where a CIPV is detected, for example, through image recognition utilized upon a plurality of sequential images captured by a camera device. At step 512, CIPV data is generated and categorized, including vehicle lateral position, vehicle speed, etc. At step 514, lane marking data is generated including center of lane data, lane polynomials, etc. At step 516, a quality of the CIPV is determined, with an additional step 518 including measuring CIPV oscillation, for example, calculating energy from an FFT operation, and with additional step 520 including measuring CIPV stability with respect to the road, utilizing an exemplary moving average calculation. In one exemplary embodiment, step 518 compares the CIPV oscillation to a threshold oscillation value and flags the CIPV as unstable if the CIPV oscillation is higher than the threshold oscillation value. In one exemplary embodiment, step 520 compares the CIPV stability with respect to the road to a threshold stability with respect to the road value and flags the CIPV as unstable if the CIPV stability with respect to the road is less than the threshold stability with respect to the road value. At step 522, additional data related to the CIPV is considered, for example, including activation of turn signals. At step 524, additional data related to lane geometry such as lane exits is considered. At step 526, data from steps 516, 522, and 524 are utilized to deterministically clean false positives and false negatives from the determination. At step 528, a determination is made whether the CIPV is stable enough to warrant a high-quality candidate designation. If the CIPV is determined to be a high-quality candidate, the process advances to step 530 where data from the CIPV is utilized as an input for breadcrumbing navigation. If the CIPV is determined not to be a high-quality candidate, the process advances to step 532, where the CIPV is rejected as a candidate for breadcrumbing navigation. In one embodiment, the driver can be notified if the CIPV is rejected at step 532. Process 500 can be reiterated for a series of CIPV targets, with the vehicle continuing to search for high-quality CIPV targets to follow and utilize for breadcrumbing navigation. Process 500 is provided as an exemplary process to evaluate and selectively utilize data from a CIPV for breadcrumbing navigation. A number of similar processes are envisioned, and the disclosure is not intended to be limited to the examples provided herein,

Navigation plots described herein can be useful to command navigation of a fully autonomous vehicle. Similarly, navigation plots described herein can be useful to command navigation of a semi-autonomous vehicle, for example, to provide automated braking, lane-tending, or obstacle avoidance. Similarly, navigation plots described herein can be useful to provide navigational aids such as projected graphics or generated sounds to aid a driver in efficiently controlling a vehicle. Examples are provided herein of how generated navigation plots can be utilized. Other embodiments are envisioned, and the disclosure is not intended to be limited to the examples provided herein.

A breadcrumbing navigation path, once generated by the present process and system, can be useful to create or influence a fused navigation path useful to guide or autonomously drive the vehicle. Such a breadcrumbing navigation path or, in particular, a determination of high oscillation or low stability of a CIPV upon a drivable surface proximate to the vehicle can be used to further modulate other factors such as distance kept away from the CIPV. For example, if a CIPV is scoring high marks for stability a normal following distance can be implemented. If that same CIPV begins to exhibit instability, for example, as a result of the driver becoming distracted, the higher instability or lower stability can be utilized to instruct the vehicle to be controlled to increase a distance from the CIPV based upon a decreased ability to trust that driver. In another exemplary embodiment, a determination of high oscillation or low stability, for example, determined if a quality measure for a particular CIPV falls below a full stop warranted threshold, can be used to command automatic braking or slowing of the vehicle. For example, if a CIPV begins to weave back and forth in a lane, the vehicle to be controlled can be commanded to stop to avoid the CIPV driving erratically. In another embodiment, the driver of the vehicle to be controlled can additionally or alternatively be warned, for example, with visual graphics or an audio warning, if the quality measure of a particular CIPV falls below a warning threshold.

The disclosed process and system describe an improvement of feature availability for autonomous and semi-autonomous vehicles. In conditions where some navigation processes would lack sufficient data and guidance to effectively navigate the vehicle, for example, in a construction zone with missing, contradictory, or displaced lane markings, the disclosed process and system can be used to validate and successfully utilize a path of a CIPV in front of the vehicle to be controlled to navigate the vehicle through the exemplary construction zone.

While the best modes for carrying out the disclosure have been described in detail, those familiar with the art to which this disclosure relates will recognize various alternative designs and embodiments for practicing the disclosure within the scope of the appended claims.

What is claimed is:

1. A system for closest in path vehicle following, comprising:
a sensor device of a vehicle to be controlled generating data related to a closest in path vehicle and related to a drivable surface in front of the vehicle;
a navigation control module including a computerized processor operable to:
monitor the data from the sensor device;
evaluate the data to determine a quality measure of a path followed by the closest in path vehicle;
if the quality measure of the closest in path vehicle is above a high-quality candidate threshold, generate a breadcrumbing navigation path based upon the data; and
a vehicle control module controlling the vehicle to be controlled based upon the breadcrumbing navigation path.

2. The system of claim 1, wherein determining the quality measure comprises quantifying the path followed by the closest in path vehicle with a numerical value.

3. The system of claim 1, wherein evaluating the data comprises:
determining an oscillation of the closest in path vehicle on the drivable surface based upon the data;
comparing the oscillation to a threshold oscillation value; and
determining the quality measure of the closest in path vehicle based upon the comparing.

4. The system of claim 3, wherein determining the oscillation of the closest in path vehicle comprises monitoring a heading error of the closest in path vehicle.

5. The system of claim 3, wherein determining the oscillation of the closest in path vehicle comprises monitoring a lateral position error of the closest in path vehicle.

6. The system of claim 3, wherein determining the oscillation of the closest in path vehicle comprises monitoring a relative position of the closest in path vehicle to another vehicle on the drivable surface.

7. The system of claim 3, wherein determining the oscillation of the closest in path vehicle comprises monitoring a curvature error of the vehicle.

8. The system of claim 1, wherein evaluating the data comprises:
determining a stability of the closest in path vehicle on the drivable surface based upon the data;
comparing the stability to a threshold stability value; and
determining the quality measure of the closest in path vehicle based upon the comparing.

9. The system of claim 8, wherein determining the stability of the closest in path vehicle on the drivable surface comprises evaluating whether the closest in path vehicle is tracking an established lane of travel.

10. The system of claim 8, wherein determining the stability of the closest in path vehicle on the drivable surface comprises evaluating a dynamic trajectory of the closest in path vehicle an established lane of travel.

11. The system of claim 1, wherein the sensor device comprises one of a camera device, a radar device, a lidar device, and an ultrasonic device.

12. The system of claim 1, wherein controlling the vehicle to be controlled based upon the breadcrumbing navigation path comprises:
determining a lane geometry on the drivable surface;
fusing the lane geometry with the breadcrumbing navigation path to create a fused navigation path; and
controlling a trajectory of the vehicle to be controlled based upon the fused navigation path.

13. The system of claim 1, wherein the vehicle control module further controls a distance from the closest in path vehicle based upon the quality measure.

14. The system of claim 1, wherein the vehicle control module further controls vehicle braking based upon the quality measure.

15. A system for closest in path vehicle following, comprising:
a sensor device of a vehicle to be controlled generating data related to a closest in path vehicle and related to a drivable surface in front of the vehicle;
a navigation control module including a computerized processor operable to:
monitor the data from the sensor device;
evaluate the data to determine a quality measure of a path followed by the closest in path vehicle, the quality measure comprising a numerical value quantifying the path followed by the closest in path vehicle; and
if the quality measure of the closest in path vehicle is above a high-quality candidate threshold, generate a breadcrumbing navigation path based upon the data; and
a vehicle control module controlling the vehicle to be controlled based upon the breadcrumbing navigation path.

16. A process for closest in path vehicle following, comprising:
gathering data with a sensor device of a vehicle to be controlled, the data being related to a closest in path vehicle and related to a drivable surface in front of the vehicle;
within a computerized processor,
monitoring the data from the sensor device;
evaluating the data to determine a quality measure of a path followed by the closest in path vehicle; and
if the quality measure of the closest in path vehicle is above a high-quality candidate threshold, generating a breadcrumbing navigation path based upon the data; and
controlling the vehicle to be controlled based upon the breadcrumbing navigation path.

17. The process of claim 16, wherein evaluating the data comprises evaluating a stability of the path followed by the closest in path vehicle.

18. The process of claim 16, wherein evaluating the data comprises evaluating a oscillation of the path followed by the closest in path vehicle.

19. The process of claim 16, further comprising automatically stopping the vehicle to be controlled if the quality measure of the closest in path vehicle is below a full stop warranted threshold.
